(19) United States
(12) Patent Application Publication
(10) Pub. No.: US 2023/0319466 A1
(43) Pub. Date: Oct. 5, 2023

(54) MICROPHONE MODULE

(71) Applicant: Panasonic Intellectual Property Management Co., Ltd., Osaka (JP)

(72) Inventors: Yoshimichi OOYA, Kanagawa (JP); Hisato TAKEUCHI, Kanagawa (JP); Yusuke TAKEUCHI, Kanagawa (JP)

(21) Appl. No.: 17/976,222

(22) Filed: Oct. 28, 2022

(30) Foreign Application Priority Data
Mar. 31, 2022 (JP) 2022-060293

(51) Int. Cl. H04R 3/00; H04R 1/04; H04R 1/08

(52) U.S. Cl. CPC H04R 3/00; H04R 1/04; H04R 1/08; H04R 17/02

(57) ABSTRACT

A microphone module according to the present disclosure includes a housing, a vibration sensor, and a subtractor. The vibration sensor outputs electric signals. The electric signals each represent collected sound and vibration. The subtractor outputs a subtraction signal on the basis of differential signals. The differential signals correspond to an output difference between the electric signals output by the vibration sensor.

### CROSS-REFERENCE TO RELATED APPLICATIONS

This application is based upon and claims the benefit of priority from Japanese Patent Application No. 2022-060293, filed on Mar. 31, 2022, the entire contents of which are incorporated herein by reference.

### FIELD

The present disclosure relates generally to a microphone module.

### BACKGROUND

As to microphone modules with a ceramic piezoelectric element, vibration microphones with a vibration sensor have been disclosed (for example, JP 2003-250196 A).

In a vibration sensor using a conventional piezoelectric element, two terminals, to which the piezoelectric element is connected, are used for a piezoelectric signal and a ground (GND). The ground terminal is configured to connect to a ground in common with a ground terminal of an amplifier housing. The amplifier housing is disposed in a subsequent stage of the vibration sensor and contains an amplifier. In such a vibration sensor, under a bad condition of a radio wave environment such as, for example, a scene where the vibration sensor is installed in a vehicle, a commercial frequency (or hum noise) may be superimposed onto a signal line, and thereby noise may be generated.

### SUMMARY

A microphone module according to the present disclosure includes a housing, a vibration sensor, and a subtractor. The vibration sensor outputs electric signals. The electric signals each represent collected sound and vibration. The subtractor outputs a subtraction signal on the basis of differential signals. The differential signals correspond to an output difference between the electric signals output by the vibration sensor.

### BRIEF DESCRIPTION OF THE DRAWINGS

FIG. 1 illustrates one example of a configuration of a microphone module according to a first embodiment;

FIG. 2 illustrates one example of a circuit configuration of the microphone module according to the first embodiment;

FIG. 3 is a circuit diagram illustrating one example of a circuit configuration of a microphone module according to a comparative example; and

FIG. 4 is a circuit diagram illustrating one example of a circuit configuration of a microphone module according to a second embodiment.

### DETAILED DESCRIPTION

### First Embodiment

An embodiment of a microphone module according to a first embodiment will be described below with reference to the drawings.

The microphone module according to the first embodiment is installed, for example, in an interior of a vehicle. The microphone module collects sound inside and outside the vehicle interior, and outputs a sound signal indicating the collected sound. Note that the microphone module may be used not only for such an application described above but also for other applications.

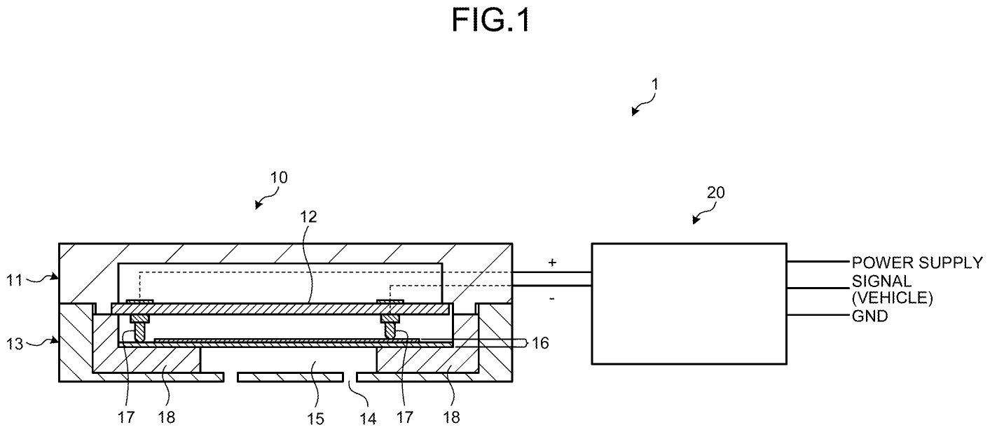

FIG. 1 illustrates a configuration of the microphone module according to the first embodiment. A microphone module 1 includes a microphone housing 10 and an amplifier housing 20. Note that the configuration of the microphone module 1 is not limited thereto.

The microphone housing 10 includes a first housing 11, a substrate 12, a second housing 13, sound holes 14, a front air chamber 15, a vibration sensor 16, contact terminals 17, and a soft member 18. Note that the configuration of the microphone housing 10 is not limited thereto.

The first housing 11 is one example of a housing. The first housing 11 is an antistatic housing and has a resistivity of 10⁶ (Ω·cm) or less, for example. The first housing 11 has, for example, a recessed shape with a hollow inside.

The first housing 11 contains the substrate 12, the vibration sensor 16, the contact terminals 17, and the soft member 18 (each described later), inside a space formed by combining the first housing 11 with the second housing 13 (also described later). Note that the first housing 11 is not limited to the antistatic housing. The first housing 11 may be a conductive housing, or may be a housing with a shielding performance further enhanced by a conductive material.

The substrate 12 is a member on which the contact terminals 17 (described later) are mounted. An end of the substrate 12 is fixed to the first housing 11. The substrate 12 is, for example, a printed circuit board (PCB). The contact terminals 17 are mounted on the substrate 12 in a manner of a surface mount device (SMD).

The second housing 13 is one example of a housing. The second housing 13 is an antistatic housing. The housing has a resistivity of 10⁶ (Ω·cm) or less, for example. The second housing 13 has, for example, a recessed shape with a hollow inside.

The second housing 13 has the sound holes 14. The second housing 13 contains the substrate 12 and the vibration sensor 16, the contact terminals 17, and the soft member 18 (each described later), inside the space formed by combining the second housing 13 with the first housing 11. Note that the second housing 13 is not limited to the antistatic housing, and may be a conductive housing.

The sound holes 14 have a configuration to collect sound in the vehicle interior. The sound holes 14 are openings of the second housing 13.

The front air chamber 15 is a space that guides the sound entering through the sound holes 14, each being the opening, to the vibration sensor 16 as described later. The front air chamber 15 is formed to be substantially perpendicular between the sound holes 14 and a microphone vibration surface.

The vibration sensor 16 is a member that is vibrated by the sound collected through the sound holes 14.

The vibration sensor 16 is, for example, a ceramic piezoelectric element. The vibration sensor 16 outputs electric signals, each representing collected sound and vibration. Specifically, the vibration sensor 16 is a member that performs conversion into electric signals with vibration entering through the sound holes 14 of the second housing 13.

The vibration sensor 16 detects force generated by the vibration. Then, the vibration sensor 16 converts the force into electric signals and outputs differential signals corresponding to an output difference between the electric signals. The converted differential signals are output to the amplifier housing 20.

The contact terminals 17 are mounted on the substrate 12 and located above the vibration sensor 16. The contact terminals 17 are disposed so as to be perpendicular to the vibration sensor 16.

The soft member 18 is configured to hold the vibration sensor 16. The soft member 18 is located between the first housing 11 and the second housing 13 to hold the vibration sensor 16.

The soft member 18 holds the vibration sensor 16, so that a peak of the vibration sensor 16 is inhibited in frequency properties. By the inhibition of the peak, variation in a sound collection level of an audible range frequency of an electric signal output by the vibration sensor 16 can be reduced. The soft member 18 is, for example, silicon.

The amplifier housing 20 contains circuitry that processes the electric signals output by the vibration sensor 16. The content of processing on the electric signals performed by the circuitry of the amplifier housing 20 will be described later.

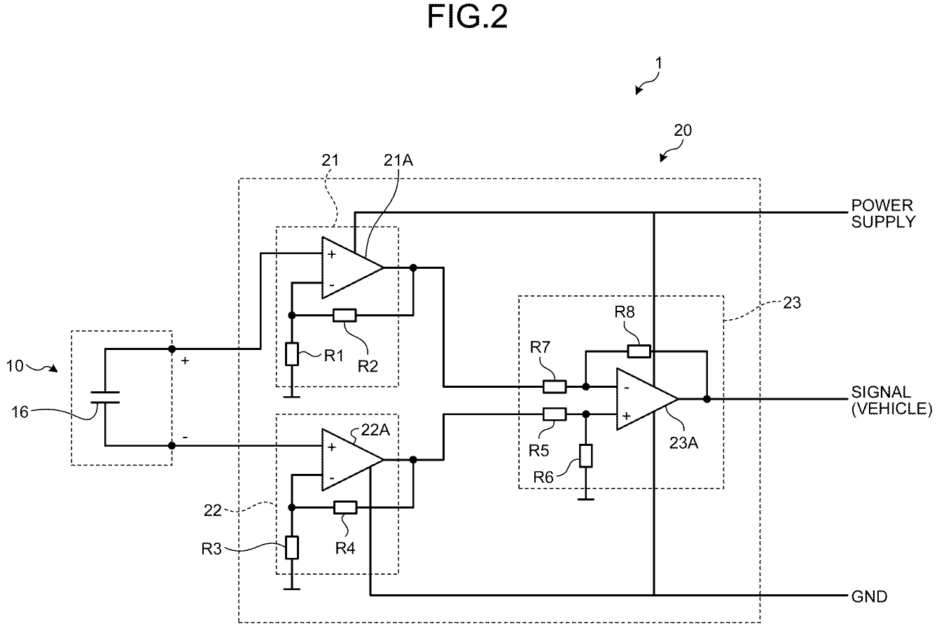

FIG. 2 is a circuit configuration diagram of the microphone module 1 according to the first embodiment. The microphone housing 10 contains the vibration sensor 16. The amplifier housing 20 contains a first amplifier 21, a second amplifier 22, and a first subtractor 23. The first amplifier 21 includes a first resistor R1, a second resistor R2, and an operational amplifier 21A. The second amplifier 22 includes a third resistor R3, a fourth resistor R4, and an operational amplifier 22A. The first subtractor 23 includes a fifth resistor R5, a sixth resistor R6, a seventh resistor R7, an eighth resistor R8, and an operational amplifier 23A. Note that the circuit configuration of the microphone module 1 is not limited to the above.

The vibration sensor 16 is connected to non-inverting input terminals of the first amplifier 21 and the second amplifier 22. The vibration sensor 16 detects force generated by vibration. The vibration sensor 16 then converts the force into electric signals and outputs differential signals corresponding to an output difference between the electric signals. One of the converted differential signals (a positive side) is output to the first amplifier 21. The other converted differential signal (a negative side) is output to the second amplifier 22.

The first amplifier 21 is configured, for example, to include the operational amplifier 21A. The first amplifier 21 is one example of an amplifier. The first amplifier 21 operates by receiving a power supply voltage at a power supply node. A ground terminal of the operational amplifier 21A of the first amplifier 21 is connected to a ground (GND) of the circuit. A non-inverting input terminal of the first amplifier 21 is connected to the vibration sensor 16. An inverting input terminal of the first amplifier 21 is connected to the first resistor R1 and the second resistor R2. An output terminal of the first amplifier 21 is connected to an inverting input terminal of the first subtractor 23 (described later) via the seventh resistor R7.

The first amplifier 21 amplifies the differential signal of the positive side output by the vibration sensor 16 and outputs, to the first subtractor 23, a signal on which impedance conversion has been performed (to lower the impedance).

The first resistor R1 is connected to the inverting input terminal of the first amplifier 21. The second resistor R2 is connected in parallel to the inverting input terminal of the first amplifier 21 and the output terminal of the first amplifier 21.

The second amplifier 22 includes, for example, the operational amplifier 22A. The second amplifier 22 is one example of an amplifier. The second amplifier 22 operates by receiving a power supply voltage at a power supply node. A ground terminal of the operational amplifier 22A of the second amplifier 22 is connected to a ground (GND) of the circuit. The non-inverting input terminal of the second amplifier 22 is connected to the vibration sensor 16. An inverting input terminal of the second amplifier 22 is connected to the third resistor R3 and the fourth resistor R4. An output terminal of the second amplifier 22 is connected to a non-inverting input terminal of the first subtractor 23 (described later) via the fifth resistor R5.

The second amplifier 22 amplifies the differential signal of the negative side output by the vibration sensor 16 and outputs, to the first subtractor 23, a signal on which impedance conversion has been performed (to lower the impedance).

The first subtractor 23 is configured to include, for example, the operational amplifier 23A. The first subtractor 23 operates by receiving a power supply voltage at a power supply node. A ground terminal of the operational amplifier 23A of the first subtractor 23 is connected to a ground (GND) of the circuit. A non-inverting input terminal of the first subtractor 23 is connected to the output terminal of the second amplifier 22, the fourth resistor R4, the fifth resistor R5, and the sixth resistor R6. An inverting input terminal of the first subtractor 23 is connected to the output terminal of the first amplifier 21, the second resistor R2, the seventh resistor R7, and the eighth resistor R8. An output terminal of the first subtractor 23 outputs an output signal to a vehicle side.

The fifth resistor R5 is connected to the output terminal of the second amplifier 22 and the non-inverting input terminal of the first subtractor 23. The sixth resistor R6 is connected to the non-inverting input terminal of the first subtractor 23. The seventh resistor R7 is connected to the output terminal of the first amplifier 21 and the inverting input terminal of the first subtractor 23. The eighth resistor R8 is connected to the inverting input terminal of the first subtractor 23.

The first subtractor 23 cancels in-phase noise through an amplified signal output by the second amplifier 22 and an amplified signal output by the first amplifier 21, and outputs, to the vehicle, a subtraction signal obtained by subtracting an opposite-phase signal.

Even when, for example, noise is superimposed on a signal line, the first subtractor 23 cancels out the noise by subtracting the differential signals output by the vibration sensor 16, so that the noise can be inhibited.

Note that the first amplifier 21 and the second amplifier 22 may have a configuration using an inverting amplifier. Moreover, a configuration using a buffer amplifier may be available.

As described above, the microphone module 1 of the first embodiment outputs a subtraction signal on the basis of the differential signals corresponding to an output difference between the electric signals output by the vibration sensor 16, each representing collected sound and vibration.

According to the above-described configuration of the first embodiment, even when noise is superimposed on a signal line, the noise is canceled out by subtracting the differential signals output by the vibration sensor 16. Therefore, noise can be inhibited, and noise resistance can be improved.

### Description of Microphone Module of Comparative Example

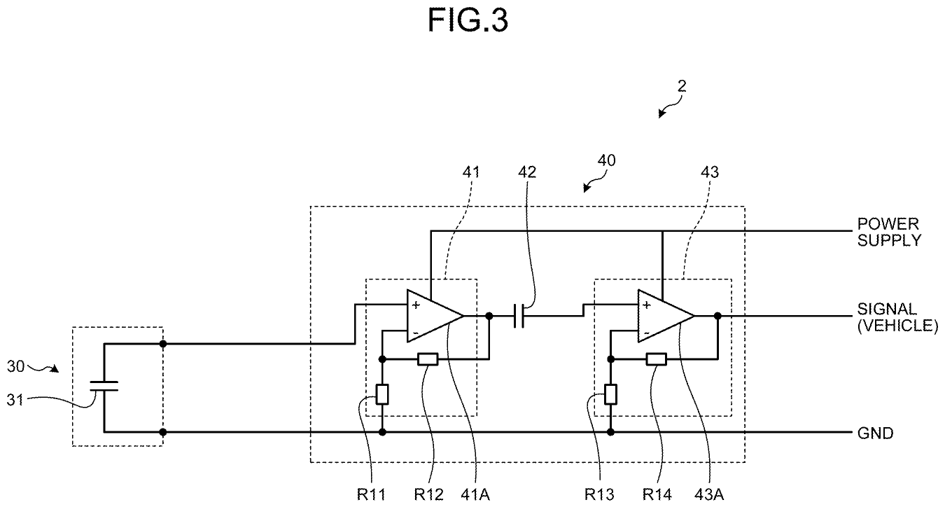

Next, a function of the microphone module 1 of the first embodiment will be described with reference to FIG. 3. FIG. 3 is a circuit configuration diagram of a microphone module 2 of a comparative example.

The microphone module 2 of the comparative example includes a microphone housing 30 and an amplifier circuit 40. The microphone housing 30 contains a vibration sensor 31. The amplifier circuit 40 includes an amplifier 41, a capacitor 42, and an amplifier 43. The amplifier 41 includes a resistor R11, a resistor R12, and an operational amplifier 41A. The amplifier 43 includes a resistor R13, a resistor R14, and an operational amplifier 43A. Note that the microphone housing 30 is constituted by an insulating member so as not to have a potential.

The vibration sensor 31 is connected to a non-inverting input terminal of the amplifier 41 and the ground. The vibration sensor 31 detects force generated by vibration and converts the force into an electric signal. The electric signal output by the vibration sensor 31 is output to the non-inverting input terminal of the amplifier 41.

The amplifier 41 is configured to include, for example, the operational amplifier 41A. The amplifier 41 operates by receiving a power supply voltage at a power supply node. The non-inverting input terminal of the amplifier 41 is connected to the vibration sensor 31. An inverting input terminal of the amplifier 41 is connected to the resistor R11 and the resistor R12. An output terminal of the amplifier 41 is connected to a non-inverting input terminal of the amplifier 43 (described later) via the capacitor 42.

The amplifier 41 amplifies the electric signal output by the vibration sensor 31 and outputs, to the capacitor 42, a signal on which impedance conversion has been performed (to lower the impedance).

The resistor R11 is connected to an inverting input terminal of the operational amplifier 41A of the amplifier 41 and the ground. The resistor R12 is connected to the inverting input terminal of the operational amplifier 41A of the amplifier 41 and an output terminal of the operational amplifier 41A of the amplifier 41. The capacitor 42 is connected to the output terminal of the amplifier 41 and the non-inverting input terminal of the amplifier 43.

The amplifier 43 includes, for example, the operational amplifier 43A. The amplifier 43 operates by receiving a power supply voltage at a power supply node. A ground terminal of the operational amplifier 43A of the amplifier 43 is connected to a ground (GND) of the circuit. The non-inverting input terminal of the amplifier 43 is connected to the output terminal of the amplifier 41 via the capacitor 42. An inverting input terminal of the amplifier 43 is connected to the resistor R13 and the resistor R14. The output terminal of the amplifier 43 outputs an output signal to the vehicle side.

The amplifier 43 outputs, to the vehicle side, a signal obtained by amplifying an electric signal that is input to the non-inverting input terminal of the amplifier 43 after transmitted via the capacitor 42.

Noise may be superimposed under a bad condition of a radio wave environment in a vehicle interior. The conventional vibration sensor 31 is connected to the ground, so that noise is superimposed on an electric signal to be output, and the electric signal with noise is output to the amplifier 41. Then, further amplification is performed by the amplifier 43 at a subsequent stage of the amplifier 41, and the noise cannot be removed in some cases.

In contrast, in the microphone module 1 of the first embodiment, the vibration sensor 16 is not connected to the ground. In the microphone module 1 of the first embodiment, even when noise is superimposed, the noise is canceled out by subtracting differential signals output by the vibration sensor 16. Therefore, the noise can be inhibited, and noise resistance is enhanced.

### Second Embodiment

Next, a second embodiment will be described. Parts of the description which are common to those of the above-described first embodiment will be appropriately omitted. Note that components similar to those in the first embodiment are denoted by the same reference signs, and description thereof will be appropriately omitted.

In the above-described first embodiment, the amplifier housing 20 is provided outside the microphone housing 10. In the second embodiment, a circuit configuration provided inside the amplifier housing 20 is contained inside the microphone housing 10.

A microphone module 3 of the second embodiment includes a microphone housing 10. On a substrate 12 of the microphone housing 10, contact terminals 17 and an amplifier circuit 50 are mounted.

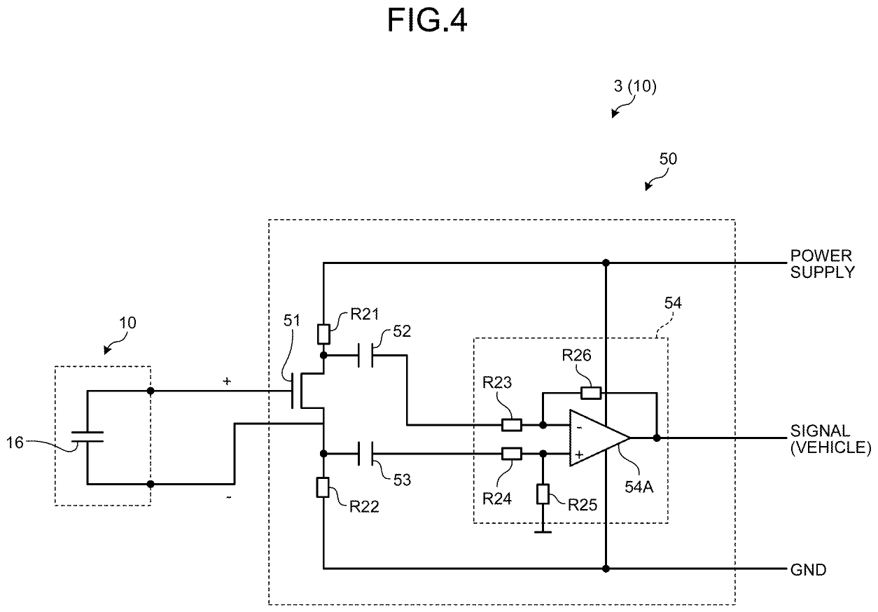

FIG. 4 is a circuit configuration diagram of the microphone module 3 according to the second embodiment. The amplifier circuit 50 includes a transistor element 51, a first capacitor 52, a second capacitor 53, a second subtractor 54, a ninth resistor R21, and a 10th resistor R22. The second subtractor 54 includes an 11th resistor R23, a 12th resistor R24, a 13th resistor R25, a 14th resistor R26, and an operational amplifier 54A. Note that the circuit configuration of the microphone module 3 is not limited thereto.

The vibration sensor 16 is connected to the transistor element 51 and the second capacitor 53. The vibration sensor 16 outputs one differential signal (a positive side) to the transistor element 51. Moreover, the vibration sensor 16 outputs the other differential signal (a negative side) to the second capacitor 53.

The transistor element 51 is, for example, a transistor of an N-channel metal oxide semiconductor field effect transistor (MOSFET) type. In the transistor element 51, a drain is connected to the ninth resistor R21 and the first capacitor 52, a source is connected to the 10th resistor R22 and the second capacitor 53, and a gate is connected to the vibration sensor 16.

The ninth resistor R21 is connected to the drain of the transistor element 51, the first capacitor 52, and a power supply. Since the ninth resistor R21 is connected to the power supply, the transistor element 51 operates. The 10th resistor R22 is connected to the vibration sensor 16, the source of the transistor element 51, the second capacitor 53, and the ground (GND).

The first capacitor 52 is connected to the drain of the transistor element 51 and an inverting input terminal of the second subtractor 54 (described later) via the 11th resistor R23. The second capacitor 53 is connected to the vibration sensor 16 and a non-inverting input terminal of the second subtractor 54 (described later) via the 12th resistor R24.

In the transistor element 51, the drain is connected to the ninth resistor R21, and the source is connected to the 10th resistor R22. Thus, the transistor element 51 outputs, to the first capacitor 52 and the second capacitor 53, an amplified signal on which impedance conversion has been performed (to lower the impedance).

Specifically, the transistor element 51 performs impedance conversion (to lower the impedance) on the differential signal of the positive side output by the vibration sensor 16 and outputs the amplified signal to the first capacitor 52. The transistor element 51 also performs impedance conversion (to lower the impedance) on the differential signal of the negative side output by the vibration sensor 16 and outputs the amplified signal to the second capacitor 53.

The microphone module 3 of the second embodiment is provided with the above-described transistor element 51. With this configuration, the microphone module 3 is capable of implementing functions of the first amplifier 21 and the second amplifier 22 included in the microphone module 1 according to the first embodiment. This allows reduction in the number of components and costs in the microphone module 3 of the second embodiment. Moreover, in the microphone module 2 of the second embodiment, the number of components can be reduced. This can contribute to reduction in size of the microphone module.

The 11th resistor R23 is connected to the first capacitor 52 and an inverting input terminal of the operational amplifier 54A of the second subtractor 54. The 12th resistor R24 is connected to the second capacitor 53 and a non-inverting input terminal of the operational amplifier 54A of the second subtractor 54. The 13th resistor R25 is connected to the non-inverting input terminal of the operational amplifier 54A of the second subtractor 54. The 14th resistor R26 is connected to the inverting input terminal of the operational amplifier 54A of the second subtractor 54.

The second subtractor 54 includes, for example, the operational amplifier 54A. The second subtractor 54 operates by receiving a power supply voltage at a power supply node. A ground terminal of the operational amplifier 54A of the second subtractor 54 is connected to a ground (GND) of the circuit. The non-inverting input terminal of the operational amplifier 54A of the second subtractor 54 is connected to the 12th resistor R24 and the 13th resistor R25. The inverting input terminal of the operational amplifier 54A of the second subtractor 54 is connected to the 11th resistor R23 and the 14th resistor R26. An output terminal of the second subtractor 54 outputs an output signal to the vehicle side.

The second subtractor 54 receives output signals of the first capacitor 52 and the second capacitor 53. The second subtractor 54 cancels in-phase noise of the input signals and outputs, to the vehicle side, a subtraction signal obtained by subtracting an opposite-phase signal. Even when, for example, noise is superimposed on a signal line of the vibration sensor 16, the second subtractor 54 cancels out the noise by subtracting the differential signals output by the vibration sensor 16. Therefore, the noise can be inhibited.

As described above, the microphone module 3 of the second embodiment includes the transistor element 51 that outputs a signal obtained by performing impedance conversion on differential signals output by the vibration sensor 16. The second subtractor 54 subtracts a converted signal output by the transistor element 51 and outputs a resultant signal. Moreover, the microphone module 3 of the second embodiment contains the vibration sensor 16, the transistor element 51, and the second subtractor 54 in a housing. Note that the polarity of output of the vibration sensor 16 is not limited to the configuration disclosed in the figure.

According to the above-described configuration of the second embodiment, even when noise is superimposed on a signal line, the noise is canceled out by subtracting the differential signals output by the vibration sensor 16. Therefore, the noise can be inhibited, and noise resistance can be improved. Moreover, the number of components can be reduced by containing the vibration sensor 16, the transistor element 51, and the second subtractor 54 in the housing. This contributes to reduction in costs and size of the microphone module.

Note that, in the above-described embodiment, when connection is performed to the ground (GND) of the circuit, the ground is not limited to a direct current (DC) ground, and may be an alternating current (AC) ground.

According to the microphone module according to the present disclosure, noise resistance can be improved.

What is claimed is:

1. A microphone module comprising:
a housing;
a vibration sensor that outputs electric signals, each representing collected sound and vibration; and
a subtractor that outputs a subtraction signal based on differential signals, the differential signals corresponding to an output difference between the electric signals output by the vibration sensor.

2. The microphone module according to claim 1, further comprising amplifiers that output amplified signals obtained by performing impedance conversion and amplification on the differential signals output by the vibration sensor,
wherein the subtractor outputs a subtraction signal obtained by subtracting the amplified signals output by the amplifiers.

3. The microphone module according to claim 1, further comprising a transistor element that outputs converted signals obtained by performing impedance conversion on the differential signals output by the vibration sensor,
wherein the subtractor outputs a subtraction signal obtained by subtracting the converted signals output by the transistor element.

4. The microphone module according to claim 3, wherein the housing contains the vibration sensor, the transistor element, and the subtractor.

5. The microphone module according to claim 1, wherein the housing has an antistatic property.

6. The microphone module according to claim 2, wherein the housing has an antistatic property.

7. The microphone module according to claim 3, wherein the housing has an antistatic property.

8. The microphone module according to claim 4, wherein the housing has an antistatic property.
